(19) United States
(12) Patent Application Publication
(10) Pub. No.: US 2013/0206251 A1
(43) Pub. Date: Aug. 15, 2013

(54) CONTAINMENT DEVICES AND METHODS FOR CONTAINING AND DISPOSING OF LIQUIDS

(71) Applicant: Sherry L. Harr, Mosca, CO (US)

(72) Inventor: Sherry L. Harr, Mosca, CO (US)

(21) Appl. No.: 13/763,539

(22) Filed: Feb. 8, 2013

Related U.S. Application Data
(60) Provisional application No. 61/597,514, filed on Feb. 10, 2012.

(51) Int. Cl. F16L 55/00; B65B 5/04; B29C 65/00

(52) U.S. Cl. CPC F16L 55/00; B29C 65/002; B65B 5/04
USPC 137/312; 29/428; 53/438; 53/429

(57) ABSTRACT

Containment devices, for example for containing fluid or contaminant spills, are described. An example containment device includes a flexible absorbent structure which is configured to absorb a first liquid material, for example a liquid hydrocarbon, antifreeze, engine coolant, or combinations thereof, while being further configured to repel and/or resist the absorption of a second liquid material, such as water. The absorbent structure may be attached to a containment structure, which is made from a flexible material impervious to the first liquid material, and which may include a pocket for receiving a reinforcement member therein. During use, a reinforcement member is provided in a pocket along a perimeter of the containment structure, the containment structure being adapted to be collapsed into a compact configuration when not use. A method of forming a portable containment device includes overlaying a first sheet of plastic with a second sheet of plastic and attaching the two sheets of plastic to one another. An absorbent layer is provided and attached to the first and/or second sheets of plastic.

### CROSS-REFERENCE TO RELATED APPLICATIONS

This application claims priority from U.S. Provisional Application No. 61,597,514, filed on Feb. 10, 2012, which is incorporated herein by reference.

### TECHNICAL FIELD

This application describes examples of spill containment devices and methods for containing liquids such as oils and other liquid materials.

### BACKGROUND

In a wide range of applications there may be a need for containing liquid spills, such as for example, oil spills or spills of other materials which may be undesirable and/or harmful to the environment. Numerous machines and industrial process, such as motorized vehicles or drilling machines as examples, may utilize various forms of liquid substances such as coolants, antifreeze, oil, and other forms of hydrocarbons, which may be deemed toxic or be characterized as contaminants/pollutants of the surrounding environment. Furthermore, some geographical regions, such as environmentally protected regions and/or wetlands, may impose substantial penalties for releasing, intentionally or inadvertently, such materials into the environment. For example, in certain areas, whenever a motorized vehicle is stopped, containment of any such liquids which may otherwise be released into the environment may be required.

Various devices and methods for containing spills are known in the art but they present numerous disadvantages. Many such devices may require substantial and complex assembly of parts in the field. Other known devices may be bulky and heavy and thus may not be suited for use in the field. Also, devices known in the art may lack an absorbent material thus requiring that the user dispose of the collected liquid prior to removal of the device from the field. Such disposal may typically be achieved by pouring the collected fluid into a canister and/or other container. However, this additional step of transferring the liquid into another container may further result in a spill. Furthermore, devices currently known in the art may leak and/or become cumbersome and heavy to transport after having been used in the field. Thus, there may be a need for an improved portable containment device and methods for containing a liquid and/or spill.

### BRIEF DESCRIPTION OF THE DRAWINGS

The accompanying drawings, which are incorporated into and form a part of the specification, illustrate one or more embodiments of the present application and, together with the description, serve to explain the principles of various embodiments. The drawings are only for the purpose of illustrating various embodiments, and are not to be construed as limiting. In the drawings:

FIG. 1 is an illustration of a containment device according to examples of the present disclosure.

FIG. 2 is a cross sectional illustration of the containment device in FIG. 1.

FIG. 3 is an illustration of a reinforcement member for containment devices according to some examples herein.

FIG. 4 is an illustration of a weight packet for use with containment devices according to the present disclosure.

FIG. 5 is a flow diagram of a method of making a containment device according to examples of the present disclosure.

FIG. 6A-6G is an illustration of certain steps for making a containment device according to the examples herein.

### SUMMARY

Containment devices, for example for containing fluid or contaminant spills, are described. A containment device according to examples of the present disclosure may include a flexible absorbent structure which is configured to absorb a first liquid material, for example a liquid hydrocarbon, antifreeze, engine coolant, or other materials that may be considered environmental contaminants. The absorbent structure may be further configured to repel and/or resist the absorption of a second liquid material, such as water. The containment device may further include a containment structure, interchangeably referred to herein as a containment shell, attached to the absorbent structure and enclosing, at least in part, the absorbent structure. The containment structure may be made from a flexible material impervious to the first liquid material.

The absorbent structure of containment devices according to this disclosure may include a fill layer, which may be an aggregate of natural or synthetic fibers, feathers, felt material, fabric pieces, or combinations thereof. The absorbent layer may also include a retention layer configured to secure the fill layer to the containment device, for example in cases where the fill layer is made from loose material such as loose fibers, feathers, or pieces of fabrics or felt. The retention layer may overly the fill material and may be secured to the containment structure along one or more attachment locations. The retention layer may be the topmost layer of the containment device when the containment device is in use. The retention layer may be formed from a permeable material so as to allow the first liquid material to pass through the retention layer and be absorbed by the absorbent structure. In some examples, the absorbent structure may include a hydrophobic material, for example within the fill layer or on top of the fill layer, or the retention layer may be coated with or otherwise treated with a hydrophobic material. Examples of hydrophobic materials include oils, fats, waxes, and generally any hydrophobic material as known in the art may be used in the examples herein. Hydrocarbons, which tend to exhibit hydrophobic properties, may also serve as the water repelling material and the absorbent structure may be treated with a hydrocarbon prior to being put in use or may advantageously rely on the hydrophobic properties of the oil being absorbed to repel or resist the absorption of water within the absorbent structure.

The containment structure according to some examples herein may include one or more pockets along a perimeter of the containment structure. In some examples, the containment structure may be formed form a plurality of plies of material and the one or more pockets may be defined between plies of the containment structure. A slit may be provided in at least one of the plies for removably inserting a reinforcement member within the pockets. In other examples, a strip of material may be attached to the containment structure, for example at certain locations along its perimeter, to define the one or more pockets. Other conventional techniques may be used to form the pockets along the perimeter of the containment structure. In some examples, the pocket may be elongated (e.g. having an aspect ratio greater than 2:1), and the longitudinal axis of the elongated pocket may be arranged substantially parallel to the perimeter of the containment structure. The pocket may include one or more opening for inserting the reinforcement member(s) or therethrough. The reinforcement member according to some examples may be a hollow tube, such as a foam cylinder. Rubber, polyvinylchloride, nylon, polyethylene terephthalate, or other suitable plastic materials may be used. In other examples, or in combination with the hallow tube member, one or more weight packs may also be used as further described herein. A weight pack may include an aggregate of granulated material, such as sand, rocks, pebbles, gravel, pellets, and the like.

Containment devices according to the present disclosure may be equipped for portability and may accordingly be collapsible, foldable or otherwise adapted to be provided from a first configuration (e.g. an unfolded configuration) to a second configuration, which is more compact than the first configuration (e.g. a folded or rolled up configuration). Containment devices of various size and shapes may be implemented according to the examples herein. Rectangular devices ranging anywhere from 2 ft by 2 ft up to 6 ft by 6 ft may be formed, or they may be larger as needed for a particular application. Containment devices according to the examples herein may be sized and/or shaped to fit under a motor vehicle. That is, an unfolded footprint of the containment devices may be such that the containment device spans the full or portions of the undercarriage of the motor vehicle. Any shapes (square, rectangular, oval, triangular, or irregular shapes) or sizes may be implemented according to the examples herein. The containment device may include one or more attachment members for securing the containment device to another structure, for example for securing the containment device to the ground or the undercarriage of a vehicle when the containment device is in use. In some instances, the attachment member may be implemented as a strap and may extend from an edge or a corner of the containment device. The containment device may further include one or more openings or grommets for pinning the containment device to the ground, or it may include hooks, magnetic means, or other fastening means for securing the containment device to the motor vehicle.

In some examples, and as will be further described herein, the containment structure may include a base portion and a sidewall portion; the sidewall portion may extend around the perimeter of the base portion. The sidewall portion may have a height which is greater than a height of the base portion and may be reinforced, as described herein, by way of a retention member which is removably or fixedly attached to the sidewall portion. In some examples, the absorbent structure may be sized to fit in the base portion, such that the absorbent structure only extends to the perimeter of the base portion. In other examples, the absorbent structure may extend at least in part over the sidewall portion, for example to provide enhances protection from fluids flowing past the edges of the absorbent structure. In some examples, the absorbent structure is fixedly to the containment structure, by stitching, fusing, gluing, or otherwise permanently attaching the two using any conventional technique. In other examples, the absorbent and containment structures may be removably attached, for example using snaps, Velcro, zippers, removable adhesive, or the like.

In further examples, the sidewall portion of the containment structure may have a height which is greater than a height of the base portion, and the absorbent structure may be configured to substantially fill the cavity defined by the base and sidewall portions. The containment device may, in this regard, resemble an enclosed box and water may generally run off the top surface and along the sides of the box by virtue of the hydrophobic properties of the absorbent structure.

Methods of making portable containment devices are described. According to one example, a method of making a portable containment device includes overlaying a first sheet of plastic with a second sheet of plastic and attaching the first sheet of plastic to the second sheet of plastic to define a containment structure. The first and second plastic sheets may have the same size and shape and may be attached to one another along their common perimeter, for example by gluing, sewing, or by other conventional means, to form a two ply structure, referred to herein as a containment structure or containment shell. One or more pockets for receiving a reinforcement member therein may be formed along the perimeter of the containment shell. The pockets may be formed by attaching the two sheets to one another at one or more locations inwardly offset from the outer perimeter of the containment shell. One or more slits may be formed in the first or second sheet at a location selected to enable insertion of the reinforcement member between the first and second sheets. In other examples, pockets may be formed by securing strips of material to one of the top or bottom surfaces of the containment shell.

An absorbent layer may be attached to at least one of the first sheet of plastic, the second sheet of plastic, or the containment structure. The absorbent layer may be glued, sewn, fused or secured by any other conventional means to the containment structure, as will be further described. In some cases, the absorbent layer may be attached to one of the first or second sheets of plastic before the sheet of plastic is secured to the other sheet. In other examples, the absorbent layer may be attached to the first and/or second sheet at the same time that the two sheets are secured to one another. In certain examples, the absorbent layer may be removably attached to the containment structure, also referred to herein as containment shell, for example to enable disposal of a soiled or damaged absorbent layer independently of the containment shell.

The absorbent layer according to the examples herein may be configured to absorb a first liquid material, such as oil, antifreeze, or other liquid compound that may be deemed a contaminate for the environment, while at the same time being configured to resist the absorption of a second liquid material, such as water. Absorption of water may be minimized or prevented, for example by coating the top most surface of the absorbent layer with a hydrophobic material or using natural or synthetic fibers which tend to resist the absorption of water. As will be further described and appreciated by those skilled in the art, oil may act as a hydrophobe and in some instances; the oil being absorbed in the containment device may itself facilitate reduced absorption of water.

As described herein, reinforcement members may be used, for example along the perimeter of the containment shell to provide structural stability for the containment shell so as to prevent the shell from collapsing and/or spilling of the first liquid outside of the containment device. According to some examples, the absorbent layer may be attached to the perimeter of the containment structure and/or the absorbent layer may extend over the walls of the containment structure. In this manner, the absorbency of the containment device may be improved by preventing fluids from pooling into corners of the containment device and spilling therefrom during disposal. In certain examples, the absorbent layer may be sized so as to fit substantially within the base of the containment shell and may be attached, permanently or removably, to the perimeter of the base.

The absorbent layer may be assembled at the same time as assembling the containment shell, or in some instances, the absorbent layer may be assembled independently from the containment shell, for example in cases when the absorbent layer is configured for removable attachment thereto. The absorbent layer may be assembled by layering sheets absorbent fabric or felt and/or aggregating pieces of fabric, felt, feathers or virtually any currently known or later developed natural or synthetic materials suitable for absorbing liquid hydrocarbons.

In some examples, the containment device may be stored and/or transported in a compact configuration. For example, when the containment device is not in use, the containment device may be folded or otherwise collapsed from its expanded configuration to a compact or folded configuration as described herein and the containment device may secured in the folded configuration by a tie or strap or by placing the folded containment device in an enclosure (e.g. a pouch). In some instances, the reinforcement members used to reinforces the walls of the containment device may be removed prior to folding the containment device. When the user wishes to contain a liquid material, the user may unfold the containment device and insert the reinforcement member(s) into the one or more pockets. The user may then place the containment device under the vehicle and/or secure the containment device thereto or to the ground. After use, the containment device may be provided back into the folded configuration and the absorbed fluid may be contained therein without a spill. In other examples, the containment device may be used to wrap, for example for transport, an object which may be coated with an environmental contaminant (e.g. a drive shaft or other vehicle or machinery components which may be coated in oil), or the containment device may be used to wrap or blanket machinery to prevent oil or other fluids from spilling out or being expelled under pressure.

### DETAILED DESCRIPTION

Certain details are set forth below to provide a sufficient understanding of embodiments of the invention. However, it will be clear to one skilled in the art that embodiments of the invention may be practiced without various of these particular details. In some instances, well-known structures, materials, and fabrication methods have not been shown in detail in order to avoid unnecessarily obscuring the described embodiments of the invention.

Containment devices and methods for making and using containment devices are described herein, as well as methods for containing and disposing of liquid hydrocarbons and/or other liquid materials. Example containment devices according to embodiments of the present invention may include a containment structure coupled to an absorbent structure wherein the absorbent structure may have a hydrophobic layer which is configured to absorb liquid hydrocarbons. Example methods for containment of liquid hydrocarbons may include the steps of providing a hydrophobic absorbent layer coupled to a containment layer between a source of liquid hydrocarbons and a surface, and absorbing a quantity of liquid hydrocarbons.

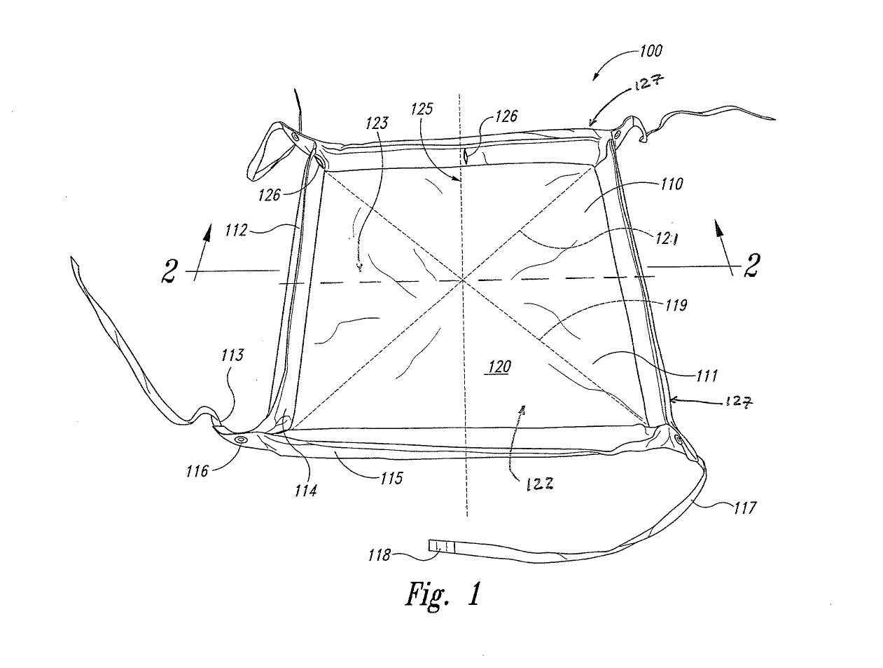

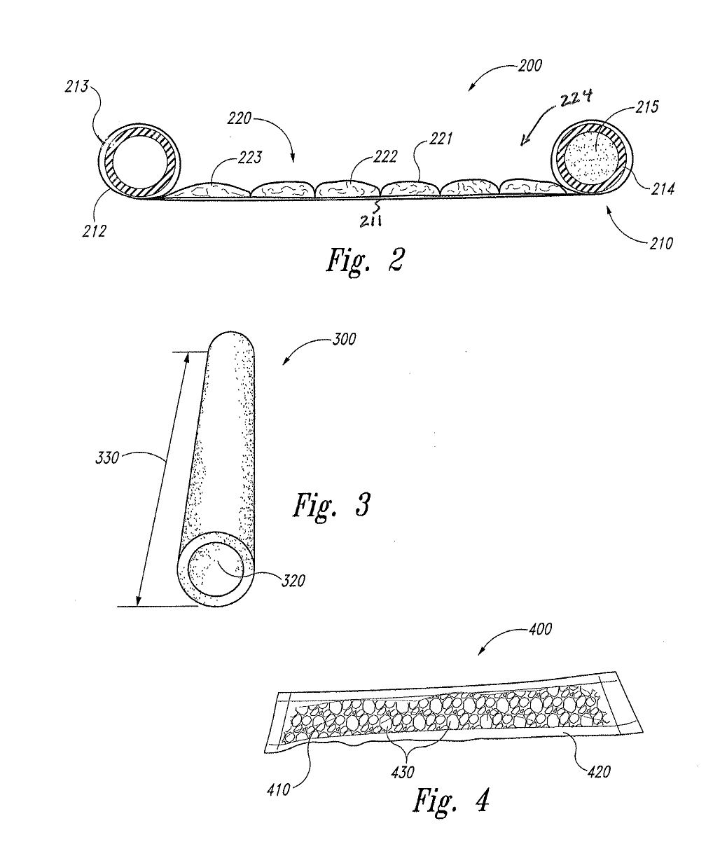

FIG. 1 shows an illustration of an example containment device according to an embodiment of the present disclosure. The containment device 100 may include a containment structure 110 and an absorbent structure 120. The containment structure may include a base 111, a sidewall 112, and an attachment member 113. The absorbent structure 120 may include an absorbent layer 121(also referred to herein as fill layer), as will be further described with reference to FIG. 2. In some examples, the absorbent structure may also include a retention layer 122, which may be a top most layer of the absorbent structure. In some examples, the containment structure 110 may include one or more layers or plies of material attached together by conventional methods and configured as described herein. The containment structure may be rectangular (as shown in FIG. 1), or it may be oval, triangular, or have virtually any other form factors as may be suited for the particular application.

The base 111 and/or sidewall 112 of the containment structure 110 may be fabricated from a flexible impervious (e.g., leak-proof) material. In some examples, the flexible impervious material may be a thin sheet of plastic material, such as Dupont's TYVEK or FLEXWRAP. In some examples, the containment structure 110 may be fabricated from various other plastic or similar imperforate materials. Certain natural or synthetic fabrics may be used, which may be coated with a resin or glue or other suitable coating to provide a flexible impermeable sheet of material. In some examples, at least portions of the containment structure 110 may be fabricated from a plastic sheet, such as for example a heavy duty 4 mil plastic sheet.

The base 111 may be implemented in a rectangular shape, an oval shape or other irregular shape as may be suited for the particular application. In some examples, the containment structure may be configured to cover an area of one square foot surface area. In some examples, devices up to 20 square feet surface area may be implemented while still remaining portable, as will be described further below. The sides 127 of the base may measure anywhere from 1 ft to about 10 feet. As would be appreciated, the containment structure may be sized to cover any desired surface area without departing from the scope of the present disclosure.

The base 111 may be attached to a sidewall 112 which may extend along a portion of or all of the perimeter of the base 111. The base 111 and sidewall 112 may be fabricated as a unitary structure as described herein. In some examples, the base 111 and sidewall 112 may be formed from a continuous sheet of material without incorporating any seams or other attachment points between said base and sidewall. In some examples, the base 111 and sidewall 112 may be fabricated as separate components and attached together by conventional means, such as stitching, gluing, fastening and/or by using other methods of attachment known in the art. The sidewall 112 may have a height and a cross sectional profile as suitable for the particular containment structure. As previously described, the sidewall 112 may be fabricated of a flexible imperforate material as will be further described. In some examples, the sidewall may be a rectangular portion having a plurality of layers of flexible material which may be attached together, such as by stitching and/or gluing at least portions of the sidewall together. In some examples, the sidewall 112 may have an oval cross sectional profile. As would be understood, the cross section and dimensions of the sidewall may be varied to suit the particular application and size of area to be covered/protected by the containment device 100.

The containment structure 110 may be configured to retain its shape when in use and it may be flexible and/or collapsible when not in use for ease of transport, for example. In some examples, the sidewall 112 of the containment structure 110 may be reinforced for added stability and weight, as will be described in more detail below. Furthermore, the reinforcement may function as a barrier against spillage of the collected liquids (e.g., by preventing any liquids contained in the device 100 from escaping from the interior of the device to a region exterior to the device).

As described herein, the containment device 100 may be configured to be collapsed to a more compact size. In some examples, the containment device 100 may be foldable, or it may be configured to be rolled up in a configuration suitable for transport and/or disposal. In some examples, the containment structure and absorbent structure attached thereto may be folded with or without removing the reinforcement members from the pockets. In some cases, the reinforcement member may first be removed from the pocket to allow the containment device to become sufficiently flexible to be folded. In other examples, the containment device may be foldable with the reinforcement members remaining secured to the containment device. The containment device may, for example, be foldable along a first diagonal line 119. After folding the containment device along the first diagonal line, the containment device may be further folded along a second diagonal line 121 to provide the containment device in the compact configuration. In further examples, the containment device may continue to be folded along diagonal lines to provide the containment device in a sufficiently compact configuration for transport, storage, and/or disposal. In other examples, the containment device may be collapsed by rolling it up into a generally cylindrical shape. In yet other examples, the containment device may be folded along lines (e.g. 123, 125) generally perpendicular to the sides of the containment device.

The containment structure 110 may include one or more attachment members 113 for securing the containment structure 110 to another structure and/or for retaining the containment structure 110 in a folded/collapsed configuration, as described herein. The attachment member 113, which may be a durable flexible strap, which may be attached to the containment structure 110, for example by gluing, fusing, or stitching the strap thereto. The containment structure 110 may also include one or more holes 116 positioned about the perimeter of the device 100. In some examples, the holes 116 may include reinforcement material, such as grommets, for example, for added durability of the holes. The holes 116 may also be used for tensioning the device and/or securing the device into place. For example, grommet holes may be installed along one or more edges of the device to allow the device to be tied down, nailed down, or otherwise secured to any type of site where its use is required or needed. In some examples, the attachment member 113 may be attached to the containment structure 110 through holes 116 rather than being fixedly attached to the perimeter of the device as is shown in FIG. 1. Furthermore, the containment device may include one or more fastening mechanisms (e.g. 118) to facilitate securing the containment device to other structures and/or for retaining the containment device in the compact configuration. The fastening mechanism may include but are not limited to buckles, ties, pins, snaps, Velcro components, or combinations thereof.

The sidewall 112 may include one or more sleeves and/or pockets 115, which may be defined between layers of the containment structure 110. One or more openings 126 may be provided through one or more of the layers to allow for inserting a reinforcement member 114 therein. In some examples, the reinforcement member 114 may be permanently attached to the containment structure or it may be removably provided within one or more of the sleeves and/or pockets 115. In some examples, the reinforcement member 114 may by an elongated member, such as a solid or a hollow cylindrical structure. For example, the reinforcement member may be a foam tube, as depicted in FIG. 3. The reinforcement member 114 may be a solid or hollow foam block which may have virtually any cross section profile. In further examples, the reinforcement member 114 may be made from virtually any plastic materials. The reinforcement member 114 may be sewn in or otherwise secured into sleeves and or pockets of the backing material. In some examples, a filler material may be used for added weight, such as for example pea gravel, which may be loose within the reinforcement member 114 (e.g., a foam tube) or which may be placed and sealed in a container, such as a plastic bag, and the bag may be placed in the hollow region of the tube. The reinforcement member 114 and the filler material may then placed into the pockets or sleeves 115 of the containment structure 110.

In some examples, the sleeves and/or pockets 115 may be filled with the filler material for added weight and stability, for example. In some examples, the filler material may be an aggregate of pea gravel, rocks, sand, pellets or other granulated or solid material. In some examples, wheat, beans, rice or other organic materials may be used. In some examples, the filler material may be any combination of organic or inorganic materials as may be suited for the particular application. In some examples, the filler material may be encapsulated in an enclosure (as shown in FIG. 4 and described further below) and placed in the pockets 115. In some examples, loose filler material may be disposed within the sleeves and/or pockets, or it may be placed in the hollow region of a hollow foam block (as shown in FIG. 2 and described herein).

FIG. 2 is a cross sectional illustration of an example containment device according to an embodiment of the present invention. The containment device 200 may include a containment structure 210 and an absorbent structure 220. The containment structure may include a base 211 and one or more walls 212. The walls 212 may be disposed about a perimeter of the base 211 and may be attached to the base such that a cavity or containment region 224 is defined between the base 211 and walls 212. The walls 212 may be configured to withstand lateral forces so that the containment structure 210 may retain its shape even if subjected to lateral loading. For example, the walls 212 may be implemented as a substantially continuous structural member (e.g., a loop that circumscribes the perimeter of base 211) such that a lateral load at one location along the walls 212 may be distributed along the circumference of the wall. Furthermore, the walls 212 may include one or more regions 213 interior to the walls, wherein a reinforcement member 214 may be placed. In some examples, and as further described herein, a filler material 215 may be included interior to regions 213.

As described, the absorbent structure 220 may include an absorbent layer 221. The absorbent layer 221 may include a material 222 (e.g. fill material) configured to absorb organic and/or mineral oils (e.g hydrocarbons), organic acids, antifreeze, vehicle coolants, and/or various heat transfer agents, or other liquid compounds which may be deemed contaminants for the environment. In some examples, the absorbent structure may further include a porous retention layer 223 which may be disposed over the absorbent layer 221. In some examples, the absorbent material 222 may be covered in full or in part by the retention layer 223, which may be fabricated from a permeable material, such as a netting, or a mesh, as examples.

The retention layer 223 may be sewn, glued or otherwise attached by conventional means to the remaining layers of the device. In some examples, a crossing stitch may be used to bind the absorbent layer to the retention layer and/or a layer of the base 211 of the containment structure. In this manner, additional strength and stability may be imparted to the absorbent layer 221 (e.g. by creating a cross-stitched truss-type structure). The absorbent layer 221 may be sewn, glued or affixed by conventional methods to a surface of the base 211. In some examples, where the absorb layer is sewn in, an additional layer 225 may be added to the bottom of the containment structure to prevent any possible leaks that may result due to the presence of stitching holes. In this manner the containment structure may function as an impermeable barrier between the absorbent structure and the environment and may contain any liquids collected at the absorbent layer.

In some example, the absorbent layer 221 may include a hydrophobic material and/or be treated with a hydrophobic chemical. In some examples, the retention layer 213 may include a hydrophobic material and/or be treated such that it exhibits hydrophobic properties. In some examples, the absorbent material may include feathers, which may be loosely packed, or woven. In some examples, the absorbent layer 221 may be assembled from continuous sheets of an absorbent fabric or it may include tightly woven feathers, or other woven or packed fibers. While not limiting the scope of the present disclosure, feathers may be particularly suitable as fill material due to their ability to absorb oils while at least partially repelling water. In this manner, the oils may be pulled into the absorbent layer and collected for disposal, while water may be separated and removed from the containment device. In further examples, the absorbent material 222 may include earth soils. Other materials, including but not limited to polymers, synthetic and/or natural fabrics or pieces of fabric may be used as the absorbent material. The absorbent material 222 may be arranged in sheets cut to a desired length and width, or it may be in the form of scrap material, fibers, and/or filaments, which may be packed and/or woven together to form the desired shape and size of the absorb layer 221.

In some examples, the absorbent structure 220 may have a thickness which may be equal to or less than the height of the walls 213. The absorbent structure 220 may extend to the top portion 226 of the device such that the cavity 224 is substantially enclosed and/or filled by the absorbent material 222. In such examples, the hydrophobic properties of the absorb layer 221 and/or the retention layer 213 may cause water to simply flow off the edges of walls 213 the device, while oils and/or other chemicals are drawn into the absorb layer. In other examples, and as depicted in FIG. 2, the absorbent structure may only partially fill the cavity 224. In yet other examples and as will be described further, the absorbent structure 220 may extend at least along portions of the walls 213.

FIG. 3 shows an illustration of an example reinforcement member according to an embodiment 300 of the present disclosure. In some examples, the reinforcement member may be a longitudinal member having sufficient stiffness to retain its shape, and may be sized such that it fits within the sleeves and/or pockets of the containment structure. As described herein, the reinforcement member 300 may be a hollow foam cylinder 310. The hollow foam cylinder 310 may have an inner region 320 inside which an additional filler material may be included as described. The cylinder 310 may have a length 330 which may be the same as a length of the sidewall of the containment structure. However, as can be appreciated two or more cylinders of shorter length may placed in series within the sleeves to provide reinforcement for the full length of a sidewall. The plurality of cylinders may or may not be joined. In some examples, having a discontinuity along the length of the reinforcement member may offer additional advantages such as allowing the side walls to be collapsed when the device is being folded. Other form factors, in addition to cylindrical members, may of course be used without departing from the scope of the present disclosure.

FIG. 4 shows an example of a weight pack of filler material according to an embodiment of the present invention. The weight pack 400 may include filler material, which may be pea gravel, rocks, sand, or other pellet or solid material provided for added weight and stability, for example. In some examples, wheat, beans, rice or other organic materials may be used in the place of the inorganic solids depicted in FIG. 4. Pelletized plastics, such as rubber balls or chunks of plastic material may also be used. In some examples, the filler material may be encapsulated in an enclosure 410. The enclosure 410 may be a vacuum bag 420 made form a plastic material which encapsulates a filler material 430, for example the pea sized gravel sealed therein, to form the weigh pack 400. The weight pack may be permanently installed in the pockets, which pockets may or may not be sealed. In some examples, the weight packs may be removable and may be configured to be disposed inside the pockets when the device is in use (e.g. in the field, when the device is in an expanded configuration). As described herein, one or more cuts or slits may be provided in the pockets such that the reinforcement member and/or filler material may be deposited and/or removed from the pockets. In some examples, the filler material may be loose material disposed directly within the sleeves and/or pockets, or placed in the hollow region of a hollow retention member, as described.

The methods and systems described herein may limit or prevent liquids from escaping into the environment, and potentially contaminating the environment. In some examples, the methods and systems described may be utilized to limit or prevent spills from oils (e.g. hydrocarbons) and its byproducts. As is known, various forms of oils are frequently used as lubricants and/or an energy source (e.g. fuel for internal combustion engines) for numerous types of machines, motorized vehicles, and/or industrial processes. However, many oil products, as well as non-oil products such as antifreeze may be undesirable for the environment or be deemed toxic. As can be appreciated, motorized vehicles may have the potential to cause oil product to be accidentally released into the environment, such as in the case of an antifreeze leak from a broken radiator hose to a simple oil drip from a gasket, a filter, or a loose mechanical connection.

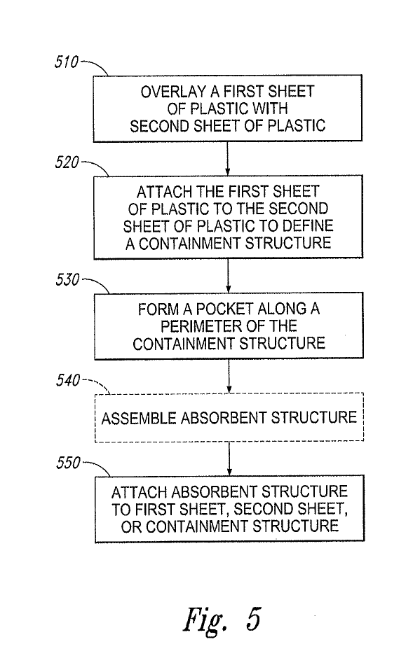

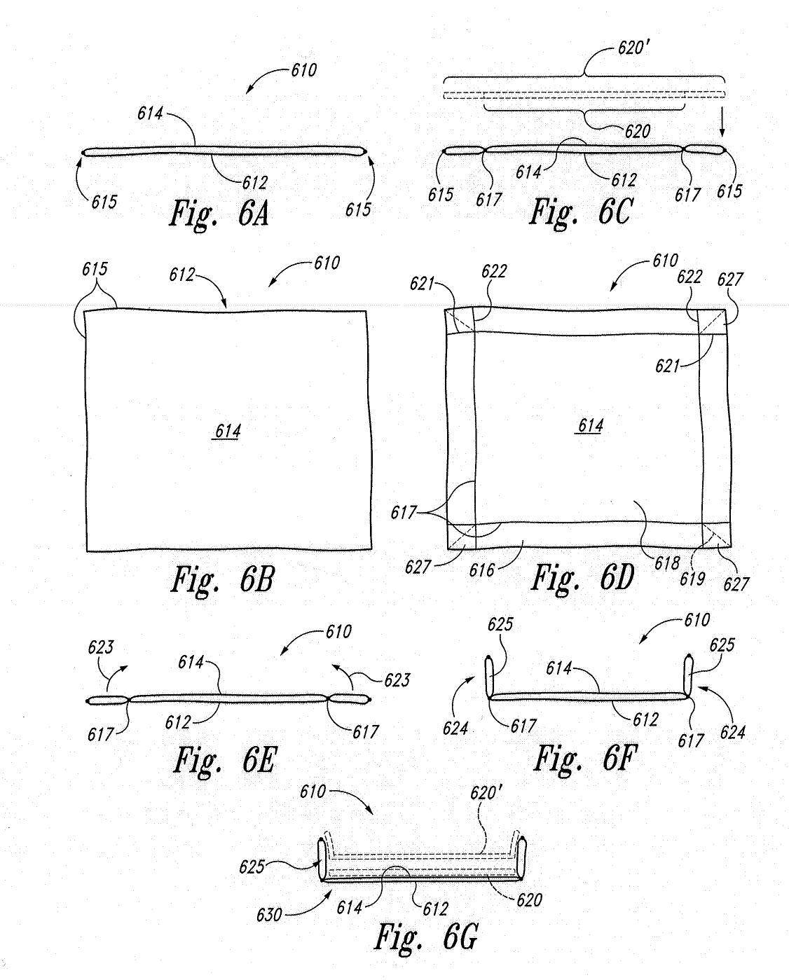

Examples of methods of making containment devices according to the present disclosure will be further described with reference to FIGS. 5 and 6. An example method of making a device according to embodiments of the present invention may include the steps of forming an absorbent structure, and securing the absorbent structure to at least a portion of a containment structure. It will be understood that the absorbent structure may be secured to the containment structure or shell during or after the assembly of the containment shell as will be further described.

FIG. 5 depicts a flow diagram of an example method of making a containment device. According to some examples, forming or assembling the absorbent structure (see e.g., box 540) may include packing, weaving, or otherwise assembling an absorbent material or fill material, which may comprise fibers, feathers, or other natural or synthetic materials selected for their absorptive properties, and placing a retention layer, made of a porous material, such as a mesh material or a fine net, on at least one side of the absorbent layer. In some examples, both sides of the absorbent layer may be enclosed using a retention layer and the three layers may then be secured together, by stitching or gluing, for example, to form the absorbment structure. The retention layer may prevent the absorbent layer from separating during transport, use, and/or disposal. The retention layer may be attached, for example sewn into, the absorbent structure along the edges of the absorbent structure. In some examples, the absorbent structure may be further reinforced. For example, the retention layer may be attached to the absorbent structure across a length and/or width of the absorent structure, such as by stitching the retention layer several times across the width of the absorbent structure. This may allow the retention layer, which may be a mesh or netting to be secured into place against the effects of wind for example.

The absorbent structure may be centered on one or more layers of impermeable material, such as heavy duty plastic, canvas, vinyl or house wrap (e.g. TYVEK). The absorbent structure may be secured to the impermeable material which may be arranged as described herein to form the containment structure of the device (see e.g., box 550).

In other examples, a containment structure may be assembled in advance of attaching the absorbent structure thereto, as shown in boxes 510-530. With further reference to FIGS. 6A-6G, certain steps for forming a containment device according to some examples herein will be described.

As depicted in FIGS. 6A-G, in simplified cross-sectional view of 6A and simplified plan view 6B, a first sheet of plastic 612 may be overlaid with a second sheet of plastic 614 and attached to one another, for example along perimeter lines 615 to define the containment shell 610. As pocket 625 may be formed along a perimeter of the containment shell 610. The pocket 625 may be formed by attaching the first and second sheets to one another at second attachment locations (e.g. lines 617) which are inwardly offset from the perimeter 615 (as depicted in cross-section FIG. 6C and plan view FIG. 6D). One or more openings as described herein (e.g. opening 126 in FIG. 1) may be formed in the first sheet 612 or the second sheet 614 at a desired location along the perimeter region 616 defined by the lines 615 and 617.

An inset area 618 is defined between the lines 617 generally corresponding to the footprint of the containment device when in use. The perimeter region 616 defining a portion of the wall of the containment structure. While lines 617 are depicted in FIG. 6D as spanning the full distance between the sides of the sheets of plastic (e.g. 612 and 614), in some examples, the lines 617 may only extend along the sides of the inset area 618. That is, attachment (e.g. stitch lines) may only be placed along the sides of inset 618 without extending to the perimeter lines 615.

The absorbent structure 620 or 620′ may be attached to the containment shell 610 at this point as shown in FIG. 6A, or it may be attached at a later point as shown in step FIG. 6G. The absorbent structure 620 may have a size substantially corresponding to the size of the inset area 618, or in certain examples, the absorbent structure 620′ may be sized to extend along the perimeter region 616, which will define the walls of the containment device.

As shown in FIG. 6E-F, a three dimensional structure may be defined by folding the perimeter region 616 upward as indicated by arrows 623. The upwardly extending perimeter region will define the walls 624 of the containment shell. As described previously a pocket is defined between inner and outer surfaces of the walls 624 by virtue of the two sheets of plastic not being attached to one another along the perimeter region. The pocket may be used as described herein to receive a reinforcement member, for example for stabilizing the containment device while in use.

In some examples, the perimeter region 616 may be secured in the upward folded position temporarily (e.g. by using Velcro, snaps, or pins) or permanently (by stitching or gluing facing sides of the wall along the lines 621 and 622). The excess material 627 of sheets 612 and 614 may be cut out along lines 621 and 622 prior to stitching the two together, or after. In other examples, the excess material 627 may be folded along line 619, taking a generally triangular shape when the perimeter region 616 is folded upward. The excess material 627 may be retained in some examples and used to anchor the attachment strap thereto. For example, the strap may be sandwiched between the sheet material on each side of line 619 for more secure attachment of the strap to the containment structure. As further shown in step 4, and in cases in which the absorbent structure 620, 620′ was not previously attached, the absorbent structure may be placed into the containment shell to line, at least in part, the cavity 224.

As previously described, the containment device may be designed to cover any desirable shape and size by cutting the impermeable material to the desired size, for example. One advantage of providing an absorbent structure over the containment structure may be to more effectively collect any spilled liquids and/or preventing a leak of said liquids through to the underlying surface. Another advantage may be that providing such an absorbent structure may obviate the need for transferring collected liquids into another container and thus risking a spill. Moreover, the bottom layer (e.g. a bottom surface of the containment structure) may be fabricated from a smooth material which may have low coefficient of friction against the surface upon which it is applied. For example, in some embodiments TYVEK layer may be used as the bottom layer which may provide a low friction sliding contact with a surface such as ice, mud, dirt or pavement. This may offer the additional advantage of ease of installation of the device underneath a stopped vehicle for example. Ease of placement and removal may be one of a number of advantages of the devices and methods described herein.

Constructing and using the device may be achieved according to methods described herein. For example, an absorbent pad may be formed by packing and/or weaving an absorbent material and securing the absorbent material to a porous top layer, for example a net or other mesh material. The absorbent material and porous top layer may be fastened together by stitching, gluing, or affixing them together by other conventional means. The absorbent pad may then be placed over and secured to an impervious layer. The impervious layer may be a sheet of leak proof flexible material which is cut to a size which is larger than the size of the absorbent pad. That is, the edges of the flexible sheet may extend beyond the edges of the absorbent pad. The absorbent pad may be secured to the impervious layer by gluing stitching, and/or attaching it to the impervious layer using techniques known in the art.

The edges of the flexible sheet may be used to form the walls of the device. In some examples, the edges of the flexible sheet may be folded to form a pocket/sleeve and the edges may then be attached to the base and/or absorbent pad. Cuts and/or slits may be formed to create an opening for accessing the packets. For example, when used in the field, it may be desirable to increase the weight of the device to prevent the device from being affected by the elements or tipped over by lateral forces exerted within the device. Accordingly, additional structures may be inserted into the slits to provide stability and/or weight to the device. The sleeves may be used to insert solid or hollow longitudinal members or loose material packed and/or encapsulated within a pack. In this manner the sleeves may be used to impart additional rigidity to the structure of the device.

The device may also be configured to be secured in place when in use in the field. One or more attachment devices, such as straps for example, may be provided at desired locations along the perimeter of the device. For example, the attachment devices may be corner straps which may be attached to one or more corners of a rectangular containment structure. In some examples, the straps may extend underneath, along a portion of the bottom surface (e.g., layer 225). In some examples, as in the case irregularly shaped devices or oval containment devices, straps may be positioned at locations along a perimeter of the device selected to provide sufficient rigidity when the device is secured to the ground and/or to the undercarriage of a machine.

One or more apertures, such as holes 116, may be provided along the perimeter of the containment device such that additional methods of attachment may be implemented. For example, additional straps and or fastening devices may be threaded through holes 116 and the device may be further secured to the ground or other structures. In addition to serving as an attachment device, the straps may be used to secure the device in a collapsed configuration. For example, and as described above, the device may be collapsible and/or foldable for ease of transport. In some instances, the containment device may be configured to be rolled into a cylindrical shape, and straps 117 may be used to secure the roll into place.

As described herein, containment devices may be implemented to provide an inexpensive portable device and methods for containing fluid leaks and/or liquid spills, such as oil spills for example. As can be appreciated by those skilled in the art, many possible uses for the methods and systems described are envisioned, including use by private or company owned vehicle operators to prevent oil pollution, as well as by mechanic and/or machine shops. The devices and methods described may be utilized on construction sites, on drilling sites, by homeowners, in farm operations and/or while using farm equipment, and by various industrial and manufacturing processes.

Devices of various sizes and construction may be implemented according to the present disclosure which may be suited for the absorption of oils, anti-freeze and/or other alcohol based compounds, acids, and/or organic byproducts. As can be appreciated, containment devices can be implemented which are suited for the containment of battery acids, and various organic acids. Some examples may include a naturalizing agent into the absorbent structure for neutralizing acids that are being collected in the device. Devices according to embodiments of the present invention may be configured for containment of other fluids and the transportation of products in which containment is necessary. For example, organic liquid byproduct, such as bodily fluids, may be contained using the devices and methods described herein. As can be appreciated, the devices and methods described may offer an inexpensive, portable, and easy to use method for discharge of fluids to the environment and/or other surfaces which the user may wish to protect. The devices described herein may offer the further advantage of ease of disposal of such fluids via incineration of the one piece unit.

In some examples, the bottom surface of the containment device may be made of or coated with a low friction material. For example, a variety of plastic material which may be impermeable to liquids such oils, certain acids, or other potential contaminants to the environment may be used to make the bottom portion of the containment structure. In other examples, the bottom surface or contacting surface of the containment device may be coated with a lubricant, a wax, or other suitable material selected to decrease friction between the bottom surface of the containment structure and the surface upon which the containment device will be placed. In other examples, the bottom surface of the containment device may be treated or otherwise provided with a thin layer of polytetrafluoroethylene (also known as TEFLON). Low friction at the bottom surface may provide certain advantages, for example such low friction may be advantageous for ease of placement of the containment device below the undercarriage of a motor vehicle. The containment device may be unfolded or unrolled, reinforcement members may be inserted in the pockets, and the unfolded and reinforced containment device may be slid under the vehicle and then secured in place (e.g. by securing the containment device to the vehicle or to the ground) using the one or more attachment members.

As will be appreciated, the containment devices described herein may be fabricated from relatively inexpensive materials and may be configured for easy containment and disposal of liquid spills. The containment devices may be single use devices, which are disposed of after one use in the field, or they may be configured to absorb sufficiently large quantities of oil, in some cases up to 2 or more gallons oil, making them suited for multiple uses. The containment device may be provided in its compact configuration after each use thereby retaining any oil that has been absorbed by the absorbent layer securely within the containment shell. In further examples, the absorbent structure may be replaceable facilitation reuse of the containment shell.

From the foregoing it will be appreciated that, although specific embodiments of the invention have been described herein for purposes of illustration, it will be understood by those skilled in the art that various modifications may be made without deviating from the spirit and scope of the invention.

What is claimed is:

1. A containment device comprising:
a containment structure comprising a flexible material impervious to a first liquid material; and
an absorbent structure enclosed, at least in part, by the containment structure and configured to absorb the first liquid material and further configured to resist absorption a second liquid material.

2. The containment device of claim 1, wherein the first liquid material is a liquid hydrocarbon, and wherein the second liquid material is water.

3. The containment device of claim 1, wherein the containment structure includes a base portion and a sidewall portion, the sidewall portion having a height which is greater than a height of the base portion, the absorbent structure extending at least partially over the sidewall portion.

4. The containment device of claim 1, wherein the absorbent structure includes a fill layer comprising an aggregate of natural or synthetic fibers, feathers, felt material, or combinations thereof, the absorbent layer further including a retention layer overlaying the fill layer and secured to the containment structure along a plurality of attachment locations.

5. The containment device of claim 1, wherein the absorbent structure comprises a permeable layer and wherein at least a portion of the permeable layer is treated with or includes a hydrophobic material.

6. The containment device of claim 1, wherein the containment structure includes an elongated pocket along a perimeter of the containment structure, a longitudinal axis of the elongated pocket disposed substantially parallel to the perimeter of the containment structure.

7. The containment device of claim 6, wherein the pocket is configured for removably inserting a reinforcement member therein.

8. The containment device of claim 7, wherein the reinforcement member is a hollow elongated member or a weight pack comprising an aggregate of sand, rocks, pebbles, gravel, pellets, or another granulated material or combinations thereof, the reinforcement member having a length corresponding to a length of the pocket.

9. The containment device of claim 1, wherein the containment structure and the absorbent structure attached thereto are further configured to be provided from a first configuration to a second configuration, which is more compact than the first configuration.

10. The containment device of claim 1, wherein a surface of the containment structure opposite the absorbent structure comprises a low friction material.

11. The containment device of claim 1, further comprising an attachment member for securing the containment device to another structure.

12. A method of making a portable containment device, the method comprising:
overlaying a first sheet of plastic with a second sheet of plastic;
attaching the first sheet of plastic to the second sheet of plastic to define a containment structure; and
attaching an absorbent layer to at least one of the first sheet of plastic, the second sheet of plastic, or the containment structure, wherein the absorbent layer is configured to absorb a first liquid material and resist absorption of a second liquid material.

13. The method of claim 12, wherein said attaching an absorbent layer includes removably attaching the absorbent layer to a perimeter of the containment structure.

14. The method of claim 12, wherein said attaching an absorbent layer includes attaching the absorbent layer to a base of a wall of the containment structure.

15. The method of claim 12, wherein said attaching an absorbent layer comprises attaching the absorbent layer to the second sheet of plastic but not the first sheet of plastic, the first sheet overlaying a surface of the second sheet of plastic opposite the absorbent layer.

16. The method of claim 12, further comprising forming one or more pockets along a perimeter of the containment structure for removably securing one or more reinforcement members therein.

17. The method of claim 16, wherein said forming one or more pockets along a perimeter of the containment structure comprises attaching the first sheet of plastic to the second sheet of plastic along attachment locations offset inwardly from a perimeter of the containment structure.

18. The method of claim 12, further comprising assembling the absorbent layer by providing an aggregate of fill material over a surface of the containment structure and overlaying the fill material with a retention layer.

19. The method of claim 12, further comprising:
providing the portable containment device from a first configuration to a second configuration, which is more compact that the first configuration; and
securing the portable containment device in the second configuration by using a retention mechanism or by placing the portable containment device provided in the second configuration into an enclosure.

20. The method of claim 19, wherein said providing the portable containment device from a first configuration to a second configuration comprises folding the portable containment device along a first folding line and subsequently folding the portable containment device along a second folding line.

21. The method of claim 25, wherein the first folding line extends along a first diagonal of the portable containment device, and wherein the second folding line extends, at least in part, along a second diagonal of the portable containment device.

22. A portable containment device comprising:
a first sheet of plastic;
a second sheet of plastic overlaying the first sheet of plastic and secured to the first sheet of plastic to define a containment shell; and
an absorbent layer attached to at least one of the first sheet of plastic, the second sheet of plastic, or the containment shell, wherein the absorbent layer is configured to absorb a first liquid material and resist absorption of a second liquid material.

23. The portable containment device of claim 22, wherein the absorbent layer is removably attached to the containment shell.

24. The portable containment device of claim 22, further comprising a reinforcement member removably secured around a perimeter of the containment shell between the first sheet of plastic and the second sheet of plastic.

25. The portable containment device of claim 22, wherein the containment shell includes a base portion and a sidewall portion, the sidewall portion having a height which is greater than a height of the base portion, and wherein the absorbent layer substantially fills a cavity defined by the base and sidewall portions.

26. The containment device of claim 22, wherein the containment structure and absorbent structure attached thereto are further configured to be provided from a first configuration to a second configuration, which is more compact than the first configuration, the containment device further comprising a retention mechanism for securing the containment device in the second configuration.
